(19) United States
(12) Patent Application Publication
(10) Pub. No.: US 2015/0089662 A1
(43) Pub. Date: Mar. 26, 2015

(54) METHOD AND SYSTEM FOR IDENTIFYING FILE SECURITY AND STORAGE MEDIUM

(71) Applicant: TENCENT TECHNOLOGY (SHENZHEN) COMPANY LIMITED, Shenzhen (CN)

(72) Inventors: Yu ZHANG, Shenzhen City (CN); Qiru CHEN, Shenzhen City (CN)

(73) Assignee: TENCENT TECHNOLOGY (SHENZHEN) COMPANY LIMITED, Shenzhen (CN)

(21) Appl. No.: 14/560,016

(22) Filed: Dec. 4, 2014

Related U.S. Application Data
(63) Continuation of application No. PCT/CN2013/076883, filed on Jun. 6, 2013.

(30) Foreign Application Priority Data
Jun. 7, 2012 (CN) 201210186579.6

(51) Int. Cl. G06F 21/60; H04L 29/08

(52) U.S. Cl. CPC G06F 21/60; H04L 67/10
USPC 726/26

(57) ABSTRACT

A method for identifying file security, obtaining a file mark of the file, obtaining application data of the file according to the file mark, obtaining a vitality according to the application data, and obtaining the file security according to the vitality. The application data of the file can be obtained through real-time user feedback, after the file vitality is obtained according to the application data, the file security can be determined according to a statistical principle and the file vitality, thus an automatically analyzing and an artificial analyzing can be neglected. A system and a storage media for identifying the file security are also provided.

### CROSS-REFERENCE TO RELATED APPLICATIONS

The present application is a continuation application of International Application No. PCT/CN2013/076883, filed Jun. 6, 2013, and claims the priority to Chinese application No. 201210186579.6 filed Jun. 7, 2012, and which are incorporated herein by reference in their entireties.

### BACKGROUND

1. Field

The present invention relates to Internet security technologies, and more particularly relates to a file security identifying method, system and storage medium.

2. Description of Related Art

Computer virus can be seen everywhere in the Internet. The computer virus can damage a user's system, steal user's data, and pose a serious threat to network security. Thus identifying the security of an executable file is very important in the present Internet field.

The conventional process of identifying file security is: first, after a suspicious executable file is found, file information and executable sample program are uploaded to a safety center. File feature is compared with feature codes in the present sample library, if the file feature corresponds to the feature codes in the present white and black lists, the file is determined to be white or black directly. If the file feature does not correspond to the feature codes, the file is analyzed automatically, and sent to a trojan analysis processing line, the file feature, behavior feature are analyzed intelligently to determine the security of the file. Those cannot be determined to be white or black will be analyzed artificially; a periodically scanning and artificial analysis method are used to determine the file security.

However, the white and black lists in the sample library are not complete, the file security cannot be determined by simple matching; such that automatic analysis and artificial analysis are needed to determine the file security. Although the automatic analysis and the artificial analysis can obtain the exact result, the automatic analysis and artificial analysis is time-consuming and has a slow response, such that the efficiency of obtaining the file security is low.

### SUMMARY

According to this, it is necessary to provide a method for identifying the file security, which can enhance the efficiency of obtaining the file security.

A method for identifying file security includes:

obtaining a file mark of a file;

obtaining application data of the file according to the file mark;

obtaining a file vitality according to the application data; and

determining the file security according to the file vitality.

Furthermore, a system for identifying file security is provided. The system includes:

a receiving module configured to receive a file mark;

a storing module configured to obtain application data of the file according to the file mark;

a processing module configured to obtain a file vitality according to the application data; and

an identifying module configured to determine the file security according to the file vitality.

Moreover, a computer storage medium comprising a computer-executable instruction is provided, the computer-executable instruction being configured to execute a method for identifying file security, the method includes:

obtaining a file mark;

obtaining application data of the file according to the file mark;

obtaining a vitality of the file according to the application data;

determining the file security according to the vitality.

In the above method and system for identifying the file security, the file mark is obtained, the application data are obtained according to the file mark. The file vitality is obtained according to the application data, the file security is determined according to the file vitality. The application data of the file can be obtained through user feedback in real-time. After the file vitality is obtained according to the application data, the file security can be determined by the file vitality according to the statistical principle, thus it is not necessary to use the time consuming automatic analysis and the artificial analysis. By the above method, an efficiency of obtaining the file security is enhanced. A system and storage media for identifying file security is also provided.

Moreover, the file determined to be security is stored in the sample library, the white list in the sample library can be further improved, the probability of obtaining the file security directly through simple matching can be increased, and the efficiency of obtaining the file security can be further enhanced.

### BRIEF DESCRIPTION OF DRAWINGS

FIG. 1 is a flow chart of a method for identifying file security according to one embodiment;

FIG. 2 is a flow chart of a method for identifying file security according to another embodiment;

FIG. 3 is a block diagram of a system for identifying file security according to one embodiment;

FIG. 4 a block diagram of a system for identifying file security according to another embodiment;

FIG. 5 is a flow chart of the method executed by the computer facilitated by storage medium; and

FIG. 6 is a block diagram of a system for identifying file security according to another embodiment.

### DETAILED DESCRIPTION

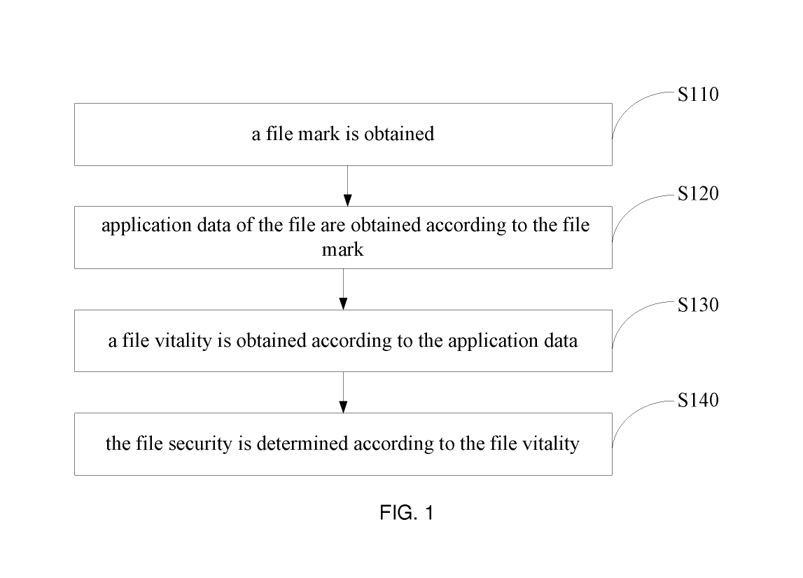

Referring to FIG. 1, an embodiment of a method for identifying file security includes the following steps:

Step S110, a file mark is obtained.

In one embodiment, each security software needs to install a client on a user's computer. The client monitors files on the user's computer in real time, when a suspicious file is found, the client sends a identifying instruction to determine whether the suspicious file is a virus. A file mark of the suspicious file is obtained when the instruction is obtained. The file mark is a unique mark of the file. In one embodiment, the file mark is a message digest value (MD5 value).

Step S120, application data of the file are obtained according to the file mark.

In one embodiment, the application data include file machine number ratio, file weekly increasing ratio, file using time ratio, and file weekly using time ratio. The file machine number ratio is the ratio of the file machine number to the total machine number. The file weekly increasing ratio is the ratio of the file machine weekly increasing number to the machine number before the file increasing. The file using time ratio is the ratio of a file using time to an operation time. The file weekly using time ratio is the ratio of a file weekly using time to a weekly operation time.

The file machine number refers to the number of machines installed the file. The total machine number refers to the number of registered machines. The file machine weekly increasing number refers to the number of newly increased machines installed the file in a week. The machine number before the file increasing refers to the registered computer number a week ago, i.e. the total machine number a week ago. The file using time refers to time of running the file. The file weekly using time refers to time of running the file in a week. The operation time refers to time of the operation of the computer installed the file in a week.

It should be noted that, in alternative embodiments, the application data is not limited to the above data. The application data may include at least one selected from a group consisting of the file machine number ratio, the file weekly increasing ratio, the file using time ratio, the file weekly using time ratio.

In one embodiment, the method for identifying file security includes counting and uploading the application data of each file corresponding to the file mark.

Specifically, the client monitors the file on the computer in real time, counts and uploads the application data of each file. After the server obtains the application data, the application data and the file mark are stored by the server correspondingly. When the identifying instruction is received, and the file mark is obtained, the corresponding application data are inquired according to the file mark. If related records are found, the application data are updated and obtained. If the related records are not found, which represents the file is a new file, a new record is created, and the application data are counted.

Step S130, a vitality of the file is obtained according to the application data.

The vitality is obtained according to a statistical principle. The file vitality indicates a popularity of the file, and it can represent coverage, using frequency, and trend of the file. The coverage is the ratio of the number of users using the file to the number of computer users in a specific range. For example, if 5000 users are random sampled, among them 4000 users are using a certain file, thus the coverage of the file is 80%. The using frequency is the ratio of the time of the user using the file to the time of the user using the computer. The trend represents the number of computer users using a file is increasing or decreasing, and represents the increasing speed or the decreasing speed. For example, if 5000 users are sampled, among them 4000 users are using this file in this week, and 4200 users are using this file in the next week, the trend of the file is increasing, and the increasing speed is 4%. The file vitality can be obtained according to a linear combination of the coverage, the using frequency, and the trend of the file and the corresponding normalization constant, and can also be obtained by one or two of the coverage, the using frequency, and the trend.

In one embodiment, after the application data of the file are obtained, the file vitality is obtained in the following manner:

vitality=file machine number ratio*a+file weekly increasing ratio*b+file using time ratio*c+file weekly using time rated,

where a, b, c, d are parameters, whose value can be selected according to the actual situation. In one embodiment, a=0.8, b=0.1, c=0.08, d=0.02.

It should be noted that, in other embodiments, the obtaining of the file vitality is not limited to the above manner. The file vitality can be obtained according to at least one selected from a group consisting of the file machine number ratio, the file weekly increasing ratio, the file using time ratio, and the file weekly using time ratio, and the corresponding parameters. And the parameters are not limited to the above values.

Step S140, the file security is determined according to the file vitality.

In one embodiment, the file is determined to be secure or not according to the file vitality in step S140. Specifically, at least one threshold value is obtained, and the file vitality is compared with the threshold value to determine the security of the file.

In one embodiment, the number of the threshold value may only be one. The threshold value is set according to the experience of a programmer. When the file vitality is less than the threshold value, the file is determined to be insecure. When the file vitality is greater than the threshold value, the file is determined to be secure.

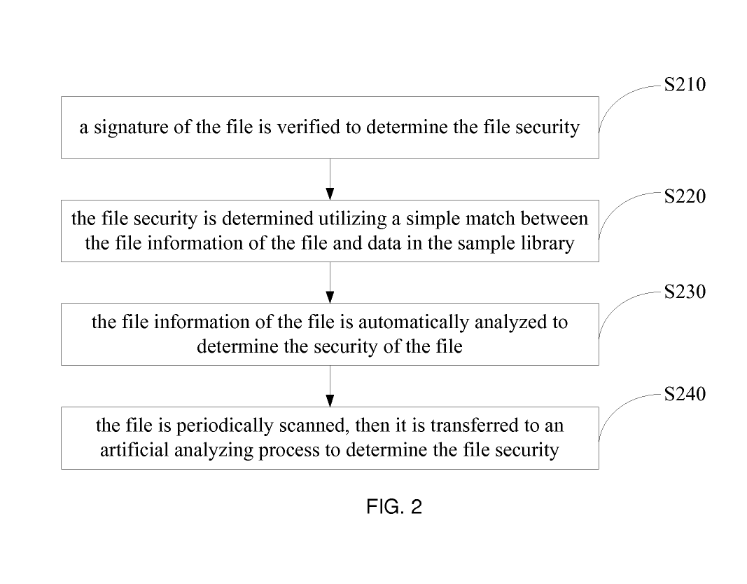

In another embodiment, the number of the threshold value is one. When the file vitality is less than the threshold value, the file is determined to be secure. When the file vitality is less than the threshold value, the file is determined to be a suspicious file. Referring to FIG. 2, when the file is determined to be a suspicious file, the file security is determined according to one or more steps of from step 210 to step 240.

Step S210, a signature of the file is verified to determine the file security.

When the file is a suspicious file, the signature is verified to determine the file security. Specifically, as a signed file cannot be modified, when the file is modified, the signature will be invalidated. Thus, when the signature of the file is verified to be reliable, it indicates that the file is not modified, the virus is not implanted, and the file is determined to be secure. When the file signature is not reliable, it indicates that the file is modified, a virus may be implanted, and the file is determined to be insecure or suspicious.

Step S220, the file security is determined by performing a simple matching between the file information of the file and data in sample library.

Specifically, the file security is determined by performing a matching between file features of the file and feature codes of a black and white list in the sample library. Feature codes are also known as computer virus feature codes, and are made by an anti-virus company. Feature codes are binary strings possessed only by the virus, which are generally determined by the anti-virus company. The string is generally an address corresponding to codes or assembly instructions in the file. In a process of the simple matching, the file features of the file are compared with the feature codes in the white and black lists, if corresponding records exist, the file security can be determined directly.

Step S230, the file information of the file is analyzed automatically to determine the security of the file.

Specifically, the file information includes a behavior feature of the file. The file feature and the behavior feature of the file are intelligently analyzed to determine the security of the file.

Step S240, the file is scanned periodically, then it is transferred to an artificial analyzing process to determine the file security.

Specifically, the file of unknown security needs to be scanned periodically, it needs to be monitored and transferred to an artificial processing platform. Thus, the staff can analyze the file sent to the artificial processing platform to determine the file security.

It should be noted that, the above steps S210 to S240 can be executed sequentially, or several steps can be selected to execute, or any one step can be selected to execute. When any one step is selected to execute, the file is determined to be secure or not.

In one embodiment, the threshold value includes a first threshold value and a second threshold value, and the first threshold value is less than the second threshold value. Specifically, in one embodiment, the first threshold value is 60%, the second threshold value is 90%. It should be noted that, in alternative embodiments, the first threshold value and the second threshold value can be variable, they can be adjusted according to different calculating methods of the file vitality and according to different parameters.

If the vitality is greater than the second threshold value, e.g. the file vitality is greater than 90% in one embodiment, the file is determined to be secure. It means the file has a wide coverage and high using frequency, which is often a system file. Accordingly, the security of the file can be determined directly according to the vitality.

If the vitality is between the first threshold value and the second threshold value, e.g. the file vitality is between 60% and 90% in one embodiment, it means the file has a certain degree of coverage and using frequency, which is often a popular installing software. The file security cannot be determined only by the vitality, and the file signature should also be verified. If the signature of the file is reliable, the file is determined to be secure.

If the vitality is less than the first threshold value, e.g. the file vitality is less than 60% in one embodiment, it means the file is an unusual software. Or if the file vitality is between the first threshold value and the second threshold value and the file signature is unreliable, the following steps are executed sequentially to determine the file security. The file security is determined by performing a simple matching between the file information of the file and data in the sample library. As for the file whose security cannot be determined through the simple matching, the file information of the file is analyzed automatically to determine the file security. As for the file whose security cannot be determined through automatic analysis, it will be scanned periodically and transferred to the artificial analysis process to determine the file security.

In one embodiment, the method for identifying the file security also includes: the file information of the file determined to be secure is stored in the sample library.

In the conventional method for identifying the file security, the file security cannot be quickly determined according to the simple matching due to the incompleteness of the white and black lists in the sample library. In the present invention, the file vitality is obtained, and the file information of the file determined to be secure according to the vitality is stored in the sample library, thus the white list in the sample library is further improved. The probability of determining the file security through simple matching can be increased, thus it is not necessary to use the time consuming automatic analysis and the artificial analysis

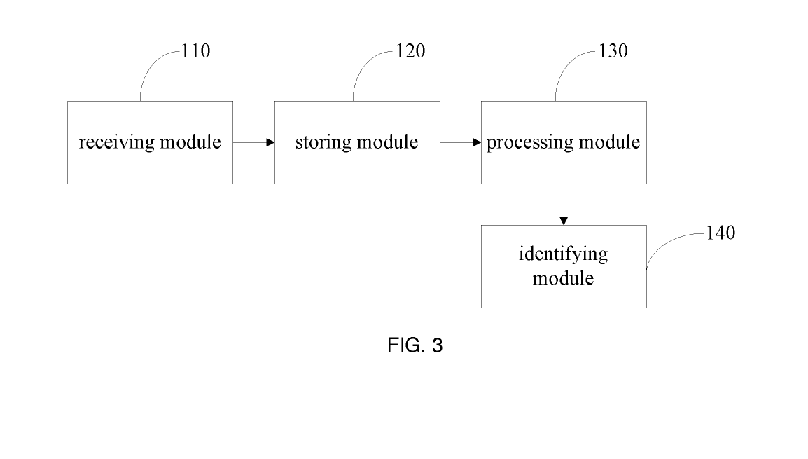

Referring to FIG. 3, a system for identifying file security is also provided in the disclosure, the system includes a receiving module 110, a storing module 120, a processing module 130, and an identifying module 140.

The receiving module 110 is configured to obtain a file mark.

In one embodiment, each security software needs to install a client on a user's computer. The client monitors files on the user's computer in real time, when a suspicious file is found, the client sends an identifying instruction to determine whether the suspicious file is a virus. When the receiving module 110 obtains the instruction, a file mark of the suspicious file is obtained. The file mark is a unique mark of the file. In one embodiment, the file mark is a message digest value (MD5 value).

The storing module 120 is configured to obtain application data according to the file mark.

In one embodiment, the application data include file machine number ratio, file weekly increasing ratio, a file using time ratio, and file weekly using time ratio. The file machine number ratio is the ratio of the file machine number to the total machine number. The file weekly increasing ratio is the ratio of the file machine weekly increasing number to the machine number before the file increasing. The file using time ratio is the ratio of file using time to an operation time. The file weekly using time ratio is the ratio of the file weekly using time to the weekly operation time.

The file machine number refers to the number of machines installed the file. The total machine number refers to the number of registered machines. The file machine weekly increasing number refers to the number of newly increased machines installed the file in a week. The machine number before the file increasing refers to the number of registered computers a week ago, i.e. the number of total machines a week ago. The file using time refers to time of running the file. The operation time refers to the time of the computer installed the file in an operation state. The file weekly using time refers to time of running the file in a week. The weekly operation time refers to time of the operation of the computer installed the file in a week.

It should be noted that, in other embodiments, the application data is not limited to the above data. The application data may include at least one selected from a group consisting of the file machine number ratio, the file weekly increasing ratio, the file using time ratio, the file weekly using time ratio.

In one embodiment, the system for identifying file security also includes a data collecting module, the data collecting module is configured to count and upload the application data of each file corresponding to the file mark.

Specifically, the data collecting module monitors the file on the computer in real time, counts and uploads the application data of each file. After the server obtains the application data, the application data and the file mark are stored by the server correspondingly. When the identifying instruction is received, and the file mark is obtained, the corresponding application data are inquired according to the file mark. If related records are found, the application data are updated and then obtained. If the related records are not found, it means the file is a new file, a new record is created, and the application data are counted.

The processing module 130 is configured to obtain vitality of the file according to the application data.

The vitality is obtained according to a statistical principle. The file vitality indicates a popularity of the file, and can represent coverage, using frequency, and trend of the file. The coverage is the ratio of the number of users using the file to the number of computer users in a specific range. For example, if 5000 users are random sampled, among them 4000 users are using one file, thus the coverage of the file is 80%. The using frequency is the ratio of the time of the user using the file to the time of the user using the computer. The trend represents the number of the computer users using a file is increasing or decreasing, and represents the increasing speed or the decreasing speed. For example, 5000 users are random sampled, among them 4000 users are using this file in this week, and 4200 users are using this file in the next week, the trend of the file is increasing, and the increasing speed is 4%. The vitality of the file can be obtained according to a linear combination of the coverage, the using frequency, the trend of the file and the corresponding normalization constant, and can also be obtained by one or two of the coverage, the using frequency, and the trend.

In one embodiment, after the storing module 120 obtains the application data, the processing module 130 obtains the vitality of the file in the following manner:

vitality=file machine number ratio*a+file weekly increasing ratio*b+file using time ratio*c+file weekly using time ratio*d.

a, b, c, d are parameters, whose value can be selected according to the actual situation. In one embodiment, a=0.8, b=0.1, c=0.08, d=0.02.

It should be noted that, in other embodiments, the processing module 130 obtains the vitality of the file is not limited to the above manner. The file vitality can be obtained according to at least one selected from a group consisting of the file machine number ratio, the file weekly increasing ratio, the file using time ratio, and the file weekly using time ratio, and the corresponding parameters. And the parameters are not limited to the above values.

The identifying module 140 is configured to determine the file security according to the vitality.

In one embodiment, the identifying module 140 determines the file to be secure or not according to the vitality. Specifically, the identifying module 140 obtains at least one threshold value and compare the vitality with the threshold value to determine the security of the file.

In one embodiment, the number of the threshold values may only be one. The threshold value is set according to the experience of a programmer. When the vitality is less than the threshold value, the identifying module 140 determines the file to be insecure. If the vitality is greater than the threshold value, the identifying module 140 determines the file to be secure.

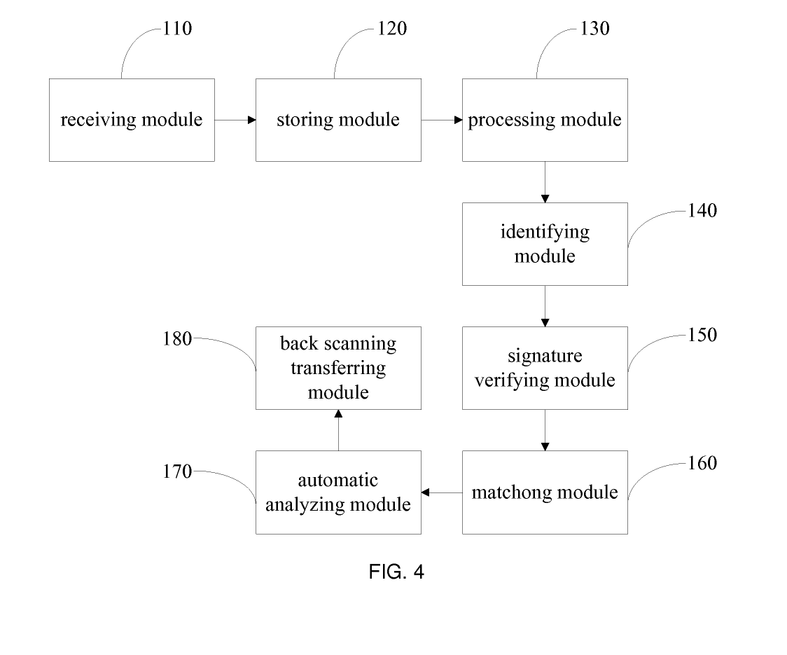

In another embodiment, the number of the threshold value is one. If the vitality is less than the threshold value, the identifying module 140 determines the file to be secure. If the file vitality is less than the threshold value, the identifying module 140 determines the file to be a suspicious file. Referring to FIG. 4, the system for identifying the file security also includes a signature verifying module 150, a matching module 160, an automatically analyzing module 170, and a scanning transferring module 180.

The signature verifying module 150 is configured to verify a signature of the file to determine the file security.

When the file is a suspicious file, the signature verifying module 150 verifies the signature to determine the file security. Specifically, as a signed file cannot be modified, when the file is modified, the signature will be invalidated. Thus, when the signature of the file is verified to be reliable, it indicates that the file is not modified, the virus is not implanted, and the file is determined to be secure by the signature verifying module 150. When the file signature is not reliable, it indicates that the file is modified, a virus may be implanted, and the signature verifying module 150 determines the file to be insecure or suspicious.

The matching module 160 is configured to perform a simple matching between the file information of the file and data in the sample library to determine the file security.

Specifically, the matching module 160 matches the file features of the file with feature codes of black and white lists in the sample library. Feature codes are also known as computer virus feature codes, and are made by an anti-virus company. Feature codes are generally binary string possesses only by the virus, and are determined by the anti-virus company. The binary string is generally an address corresponding to codes or instructions in the file. In a process of the simple matching, the file features of the file are compared with the feature codes, if comparing records are existed, the file security can be determined according to the comparing records.

The automatically analyzing module 170 is configured to automatically analyze the file information of the file to determine the security of the file.

Specifically, the file information also includes a behavior feature of the file. The automatically analyzing module 170 analyzes the file feature and the behavior feature of the file intelligently to determine the security of the file.

The scanning transferring module 180 is configured to scan the file periodically, and transfer the file to an artificial analyzing process to determine the security of the file.

Specifically, for the file of unknown security, the scanning transferring module 180 needs to scan the file periodically, and monitor and transfer the file to an artificial processing platform. Thus, the staff can analyze the file sent to the artificial processing platform to determine the file security.

It should be noted that, in other embodiments, the system may only include at least one selected from a group consisting of the signature verifying module 150, the matching module 160, the automatically analyzing module 170, and the scanning transferring module 180.

In one embodiment, the threshold value includes a first threshold value and a second threshold value, and the first threshold value is less than the second threshold value. Specifically, in one embodiment, the first threshold value is 60%, the second threshold value is 90%. It should be noted that, in other embodiments, the first threshold value and the second threshold value can be variable, they can be varied according to different calculating methods of the vitality and according to different parameters.

The system for identifying the file security also includes the signature verifying module 150, the matching module 160, the automatically analyzing module 170, and the scanning transferring module 180. If the vitality is greater than the second threshold value, the identifying module 140 is configured to determine the file to be security. If the vitality is between the first threshold value and the second threshold value, the signature verifying module 150 is called to verify the signature of the file, if the signature of the file is reliable, the file is determined to be security. If the vitality is between the first threshold value and the second threshold value, and the signature of the file is not reliable or the vitality is less than the first threshold value, the matching module 160, the automatically analyzing module 170, and the scanning transferring module 180 are called sequentially to determine the file security.

In one embodiment, the system for identifying the file security also includes a sample managing module, the sample managing module is configured to store the file information of the file determined to be secure in the sample library.

In the conventional method for identifying the file security, the file security cannot be determined quickly according to the matching module 160, because the white and black lists in the sample library are not complete. The vitality of the file is obtained in the present invention, the file information of the file determined to be secure according to the file vitality is stored in the sample library, thus the white list in the sample library is further improved. The probability of determining the file security through simple matching can be increased, and the automatic analysis step and the artificial analysis step can are not needed.

In the above method and system for identifying the file security, the file mark is obtained, the application data is obtained according to the file mark. The vitality is obtained according to the application data, the file security is determined according to the vitality. The application data of the file can be obtained through real-time user feedback, after the vitality is obtained according to the application data, the file security can be determined according to the statistical principle and the vitality, thus the time consuming automatic analysis and the artificial analysis are not needed. In the above method and system, an efficiency of obtaining the file security is enhanced.

The file determined to be secure is stored in the sample library, the white list in the sample library can be further improved, the probability of obtaining the file security directly through simple matching can be increased, the efficiency of obtaining the file security can be further enhanced.

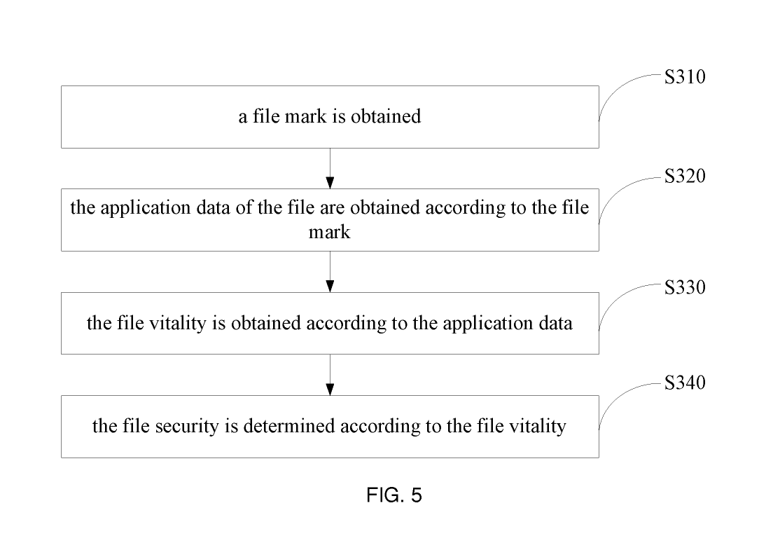

Referring to FIG. 5, a computer storage medium including a computer executable instruction is provided. The computer executable instruction is configured to execute the method for identifying the file security, the method includes the following steps:

Step S310, a file mark is obtained.

Step S320, the application data of the file is obtained according to the file mark.

Step S330, the vitality is obtained according to the application data.

Step S340, the file security is determined according to the vitality.

The execution of step S310, step S320, step S330, and step S340 are the same as the execution of step S110, step S120, step S130, and step S140, a redundant description will not be repeated here.

In one embodiment, the above method further includes: file information of the file determined to be secure is stored in the sample library.

In one embodiment, the above method further includes: application data of each file is counted and uploaded corresponding to the file mark.

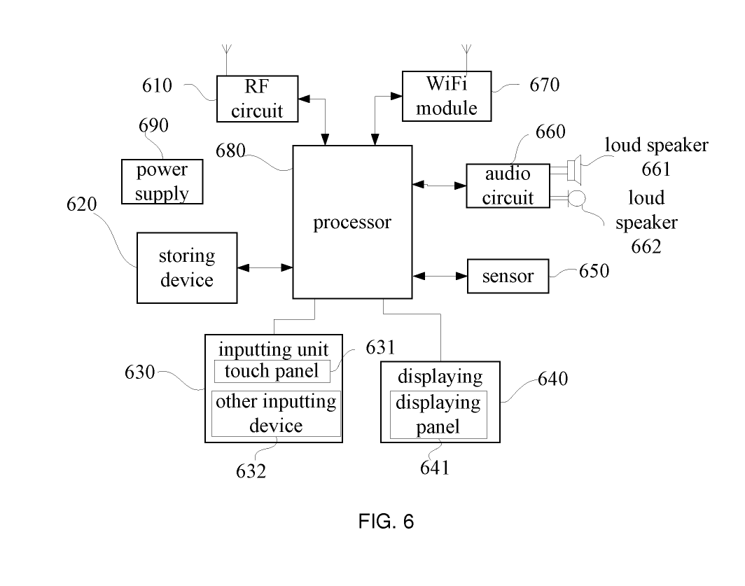

Referring to FIG. 6, another system for identifying the file security is also provided, for the purpose of illustrating, only a part related to the embodiments of the disclosure is shown, for more details, please referring to the method part of the embodiments of present disclosure. The terminal may be a mobile phone, a tablet computer, a PDA (Personal Digital Assistant), a POS (Point of Sales), a car computer etc. For example, the terminal is a mobile phone.

FIG. 6 shows a block diagram of a partial structure of the mobile phone related to the terminal provided by the illustrated embodiment. Referring to FIG. 6, the mobile phone includes: a radio frequency (RF) circuit 610, a storage device 620, an input unit 630, a displaying unit 640, a sensor 650, an audio circuit 660, a wireless fidelity module 670, a processing unit 680, and a power supply 690 etc. It shall be appreciated by those skilled in the art that, the mobile phone structure shown in FIG. 6 is not intended to limit the mobile phone, the mobile phone may include more or less components than that shown in FIG. 6, or a combination of the components, or different arrangements of the components.

Components of the mobile phone are illustrated with reference to FIG. 6

The RF circuit 610 is configured to receive and send a message, or configured to receive and send signal in the course of a call, when it receives downlink information of the base station, it sends the information to the processor 680; besides, uplink data is sent to the base station. Generally, the RF circuit includes but not limited to an antenna, at least one amplifier, a receiving and sending transceiver, a coupler, a low noise amplifier (LNA), a duplexer. The RF circuit 610 can also communicate with other devices through wireless communication and net. The above wireless communication can use any communication standard or communication protocol, which includes but not limited global system of mobile communication (GSM), general packet radio service (GPRS), code division multiple access (CDMA), wideband code division multiple access (WCDMA), long term evolution (LTE), email, short messaging service (SMS) etc.

The storage device 620 is configured to store programs and modules, the processor 680 runs the programs and modules stored in the storage device 620 to achieve various functions and data processing of the mobile phone. The storage device 620 mainly includes a storing program area and a storing data area, the storing program area may store an operating system, a program to achieve at least one function (for example an audio playing function or a video playing function). Moreover, the storage device 620 may includes a high-speed random access memory, and may also includes a non-violate memory, for example, at least one selected from a group consisting of a hard disk drive, a flash memory, and other solid non-violate memories.

The inputting unit 630 is configured to receive the inputting numbers or characters, and generate key signal input related to the user's setting and function control of the mobile phone. Specifically, the inputting unit 630 may includes a touch panel 631 and other inputting device 632. The touch panel 631 is also named as a touch screen, which can collect user's touch operation on the screen or near the screen (for example a user's touch operation on the touch panel 631 or near the touch panel 631 using an object or an accessory such as a finger and a touch pen), and a corresponding connecting device is driven according to the predetermined program. Alternatively, the touch panel 631 may includes a touch detecting device and a touch controlling device. The touch detecting device detects the user's touch orientation, and the touch signal, and sends the signal to the touch controlling device. The touch controlling device receives touch information from the touch detecting device and transforms the information into touch point coordinates, and then sends the coordinates to the processor 680. The touch controlling device can receive instructions from the processor 680 and execute them. The touch panel 631 can be formed in a lot of different forms, such as resistive, capacitive, infrared and surface acoustic wave. Except for the touch panel 631, the inputting unit 630 may also includes other inputting device 632. Specifically, the other inputting device 632 can include but not limited to physical keyboard, functional key (such as a volume control button, a switch button), a track ball, a mouse, and an operating lever.

The displaying unit 640 is configured to display information inputted by the user, or information provided by the user, and various menus of the mobile phone. The displaying unit 640 may includes a displaying panel 641, alternatively, the displaying panel 641 can be a liquid crystal display or an organic light-emitting diode. Moreover, the touch panel 631 can cover the displaying panel 641, when the touch panel 631 detects a touch operation on the touch panel or near the touch panel, it sends the touch operation to the processor 680 to determine a type of the touch operation. The processor 680 then provides visual output to the displaying panel 641 according to the type of the touch operation. Although the touch panel 631 and the displaying panel 641 achieve input and output function of the mobile phone as two independent components, in some embodiments, the touch panel 631 and the displaying panel 641 can be integrated to achieve input and output function of the mobile phone.

The mobile phone can also include at least one sensor 650, for example, an optical sensor, a motion sensor and other sensors. Specifically, the optical sensor can include an ambient light sensor and a proximity sensor. The ambient light sensor can adjust the brightness of the displaying panel 641 according to the brightness of the ambient light. When the mobile phone is close to the ear, the proximity sensor can close the displaying panel 641 and/or back light. As one kind of motion sensor, an accelerating sensor can detects acceleration in all directions (usually directions of three axes). When the accelerating sensor is stationary, it can detect the magnitude and direction of the gravity. The accelerating sensor can be used to recognize phone gesture (such as switching between portrait and landscape orientation, related game, magnetometer gesture calibration), and recognize vibration related function (such as pedometer, percussion) etc. The mobile phone can also be equipped with a gyroscope, a barometer, a hygrometer, a thermometer, and an infrared sensor etc.

The audio circuit 660, the loudspeaker 661, the microphone 662 can provide audio interface between the user and the mobile phone. The audio circuit 660 can send received electrical signal transformed from audio data to the loudspeaker 661, the loudspeaker 661 transforms the electrical signal to audio signal and then outputs the audio signal. On the other hand, the microphone 662 transforms collected audio signal to electrical signal, the audio circuit 660 receives the electrical signal and transforms it to audio data, and then sends the audio data to the processor 680. After the processor 680 processes the audio data, the audio data is sent to another mobile phone through the RF circuit 610, or the audio data is sent to the storage device 620 for further processing.

WiFi is a short range wireless transmission technology, the mobile phone can receive and send user's email, surf the internet and access stream media through a WiFi module 670. The WiFi module 670 can provide wireless accession to the broadband internet. Although the WiFi module is shown in FIG. 6, it is to be understood that, the WiFi module 670 is not an indispensable component of the mobile phone, the WiFi module 670 can be removed in the context of not change the nature of the illustrated invention.

The processor 680 is a control center of the mobile phone, components of the mobile phone are connected through various kinds of interfaces and circuits. The mobile phone is overall monitored through running the program and/or module stored in the storage device 620, and calling data stored in the storage device 620, and executing various kinds of functions of the mobile phone and processing data. Alternatively, the processor 680 may includes one or more processing units. Preferably, the processor 680 is integrated with an application processor and a modem processor, the application processor is mainly configured to responsible for the operating system, the user interface and the program etc. The modem processor is mainly configured to responsible for wireless communication. It is appreciated that, the above modem processor may not be integrated into the processor 680.

Although it is not shown here, the mobile phone may includes a camera and a Bluetooth module, a redundant description will not be repeated here.

In the illustrated invention, the processor 680 of the terminal also includes the following functions: executing the method for identifying the file security, which includes:

a file mark is obtained;

application data of the file is obtained according to the file mark;

a vitality of the file is obtained according to the application data;

the file security is determined according to the vitality.

Furthermore, the processor 680 of the terminal has the following function: the vitality of the file is obtained according to the application data in a following manner:

vitality=file machine number ratio*a+file weekly increasing ratio*b+file using time ratio*c+file weekly using time ratio*d, where a, b, c, and d are parameters.

Furthermore, the processor 680 of the terminal has the following function: the file security is obtained according to the vitality of the file, which includes:

at least one threshold value is obtained;

the file security is obtained according to a comparison between the vitality and the threshold value.

Furthermore, the processor 680 of the terminal has the following function: the step of determining the file security includes: determining the file to be secure or not according to the vitality, if the file is determined to be a suspicious file according to the vitality, the above method includes at least one of the following steps:

the file security is determined through verifying a signature of the file;

the file security is determined by performing a simple matching between file information of the file and data in a sample library;

the file security is determined according to automatically analyzing file information of the file;

the file is periodically scanned and sent to artificial analysis to determine the file security.

Furthermore, the processor 680 of the terminal also has the follow function: the threshold value includes a first threshold value and a second threshold value, and the first threshold value is less than the second threshold value, the step of comparing the vitality and the threshold value to determine the file security includes:

If the vitality is greater than the second threshold value, the file is determined to be secure;

If the vitality is between the first threshold value and the second threshold value, the signature of the file is verified, if the signature is reliable, the file is determined to be secure;

If the vitality is between the first threshold value and the second threshold value, and the signature of the file is not reliable, or the vitality is less than the first threshold value, the following steps are executed sequentially to determine the file security:

The file security is determined by performing a simple matching between the file information of the file and the data in the sample library;

The file is scanned and sent to artificial analysis to determine file security.

Furthermore, the processor 680 of the terminal also has the following function: the file information of the file determined to be secure is stored in the sample library.

Furthermore, the processor 680 of the terminal also has the follow function: the application data of each file are counted and uploaded corresponding to the file mark.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A method for identifying file security, comprising:
obtaining a file mark of a file;
obtaining application data of the file according to the file mark;
obtaining a file vitality according to the application data; and
determining the file security according to the file vitality.

2. The method according to claim 1, wherein the application data comprise at least one selected from a group consisting of file machine number ratio, file weekly increasing ratio, file using time ratio, and file weekly using time ratio.

3. The method according to claim 2, wherein obtaining the file vitality according to the application data comprises:
vitality=file machine number ratio*a+file weekly increasing ratio*b+file using time ratio*c+file weekly using time ratio*d, wherein a, b, c, and d are parameters.

4. The method according to claim 1, wherein determining the file security according to the file vitality comprises:
obtaining at least one threshold value; and
comparing the vitality with the threshold value to determine the file security.

5. The method according to claim 4, wherein determining the file security comprises:
determining the file to be a secure file or a suspicious file according to the vitality, when the file is determined to be a suspicious file according to the file vitality, the method further comprises at least one of the following:
verifying a file signature of the file to determine the security of the file;
performing a simple matching between file information of the file and data in a sample library to determine the security of the file;
analyzing the file information of the file automatically to determine the security of the file; and
scanning the file periodically, and transferring the file to artificial analysis to determine the security of the file.

6. The method according to claim 4, wherein the threshold value comprises a first threshold value and a second threshold value, and the first threshold value is less than the second threshold value, the step of comparing the vitality with the threshold value to determine the file security comprises:
if the vitality is greater than the second threshold value, determining the file to be secure;
if the vitality is between the first threshold value and the second threshold value, verifying the signature of the file, and if the signature of the file is reliable, determining the file to be secure; and
if the vitality is between the first threshold value and the second threshold value, and the signature of the file is not reliable, or the vitality is less than the first threshold value, the following are executed sequentially to further determine the security of the file;
performing a simple matching between file information of the file and data in a sample library to determine the security of the file;
analyzing the file information of the file automatically to determine the security of the file; and
scanning the file periodically and transferring the file to artificial analysis to determine the security of the file.

7. The method according to claim 1, further comprising:
storing file information of the file which is determined to be secure in a sample library.

8. A system for identifying file security, comprising:
a receiving module configured to receive a file mark;
a storing module configured to obtain application data of the file according to the file mark;
a processing module configured to obtain a file vitality according to the application data; and
an identifying module configured to determine the file security according to the file vitality.

9. The system according to claim 8, wherein the application data comprise at least one selected from a group consisting of file machine number ratio, file weekly increasing ratio, file using time ratio, and file weekly using time ratio.

10. The system according to claim 9, wherein the processing module obtains the file vitality in the following manner:
file vitality=file machine number ratio*a+file weekly increasing ratio*b+file using time ratio*c+file weekly using time ratio*d, wherein a, b, c, and d are parameters.

11. The system according to claim 8, wherein the identifying module is configured to:
obtain a threshold value; and
compare the file vitality to the threshold value to determine the security of the file.

12. The system according to claim 11, wherein the identifying module is configured to determine the file to be a secure file or a suspicious file according to the file vitality, the system further comprises at least one selected from a group consisting of the following modules:
a signature verifying module configured to verify the signature of the file to determine the security of the file;
a matching module configured to perform a single matching between file information of the file and data in a sample library to determine the security of the file;
an automatically analyzing module configured to analyze the file information of the file automatically to determine the file security; and
a scanning transferring module configured to scan the file periodically, and transfer the file to an artificial analysis process to determine the security of the file.

13. The system according to claim 11, wherein the threshold value comprises a first threshold value and a second threshold value, and the first threshold value is less than the second threshold value, the system further comprises:
a signature verifying module configured to verify the signature of the file to determine the security of the file;
a matching module configured to perform a simple matching between file information of the file and data in a sample library to determine the security of the file;
an automatically analyzing module configured to analyze the file information automatically to determine the security of the file; and
a scanning transferring module configured to scan the file periodically, and transfer the file to an artificial analysis process to determine the file security;
the identifying module is configured to:
if the file vitality is greater than the second threshold value, determine the file to be secure;
if the file vitality is between the first threshold value and the second threshold value, call the signature verifying module to verify the file signature, and if the file signature is reliable, determine the file to be secure; and
if the file vitality is between the first threshold value and the second threshold value, and the file signature is not reliable, or the file vitality is less than the first threshold value, call the matching module, the automatically analyzing module, and the scanning transferring module sequentially to determine the file security.

14. The system according to claim 8, the system further comprising a sample managing module configured to store file information of the file determined to be secure in a sample library.

15. A computer storage medium comprising:
a computer-executable instruction configured to execute a method for identifying file security, the method comprising:
obtaining a file mark;
obtaining application data of the file according to the file mark;
obtaining a vitality of the file according to the application data; and
determining the file security according to the vitality.

16. The storage medium according to claim 15, wherein the application data comprise at least one selected from a group consisting of file machine number ratio, file weekly increasing ratio, file using time ratio, and file weekly using time ratio.

17. The storage medium according to claim 16, wherein the step of obtaining the file vitality according to the application data comprises:
vitality=file machine number ratio*a+file weekly increasing ratio*b+file using time ratio*c+file weekly using time ratio*d, wherein a, b, c, d are parameters.

18. The storage medium according to claim 15, wherein determining the file security according to the file vitality comprises:
obtaining at least one threshold value; and
comparing the vitality with the threshold value to determine the file security.

19. The storage medium according to claim 18, wherein determining the file security comprises:
determining the file to be a secure file or a suspicious file according to the vitality, when the file is determined to be a suspicious file according to the vitality, the method comprises at least one of the following:
verifying a signature of the file to determine the security of the file;
performing a simple matching between file information of the file and data in a sample library to determine the security of the file;
analyzing the file information of the file automatically to determine the security of the file; and
scanning the file periodically, and transferring the file to artificial analysis to determine the security of the file.

20. The storage medium according to claim 18, wherein the threshold value comprises a first threshold value and a second threshold value, and the first threshold value is less than the second threshold value, the step of comparing the vitality with the threshold value to determine the file security comprises:
if the vitality is greater than the second threshold value, determining the file to be secure;
if the vitality is between the first threshold value and the second threshold value, verifying the signature of the file, and if the signature of the file is reliable, determining the file to be secure;
if the vitality is between the first threshold value and the second threshold value, and if the signature of the file is not reliable, or the vitality is less than the first threshold value, the following are executed sequentially to determine the file security;
performing a simple matching between file information of the file and data in a sample library to determine the security of the file;
analyzing the file information of the file automatically to determine the security of the file; and
scanning the file periodically and transferring the file to artificial analysis to determine the security of the file.
